(19) United States
(12) Patent Application Publication
(10) Pub. No.: US 2005/0031928 A1
(43) Pub. Date: Feb. 10, 2005

(54) Copolymer and the use of the copolymer

(75) Inventors: Takashi Ishizone, Saitama-shi (JP); Ken Yoshimura, Tsukuba-shi (JP); Daizaburo Yashiki, Tsukuba-shi (JP); Katsuhiko Iwasaki, Tsukuba-shi (JP)

Correspondence Address: FOLEY AND LARDNER;SUITE 500, 3000 K STREET NW, WASHINGTON, DC, 20007, US

(73) Assignee: SUMITOMO CHEMICAL COMPANY, LIMITED

(21) Appl. No.: 10/892,477

(22) Filed: Jul. 16, 2004

(30) Foreign Application Priority Data
Jul. 23, 2003 (JP) 2003-200307

(51) Int. Cl. H01M 8/10; C08J 5/22

(52) U.S. Cl. 429/33; 521/25

(57) ABSTRACT

The present invention provide a copolymer which exhibit high electricity generation characteristics when being used as a polyelectrolyte for fuel cell, and also provide a copolymer comprising an aromatic unit substantially free from an ion-exchange group, and an aliphatic unit having an ion-exchange group and a main chain consisting of an aliphatic repeating unit.

### FIELD OF THE INVENTION

The present invention relates to a copolymer, in more detail to a copolymer comprising an aromatic unit having substantially no ion-exchange group, and an aliphatic unit having an ion-exchange group and a main consisting of an aliphatic repeating unit.

### BACKGROUND OF THE INVENTION

For membranes of electrochemical devices such as primary batteries, secondary batteries and solid polymer type fuel cells, polymers having ion-exchange groups, namely, polyelectrolytes are used. For example, various polyelectrolytes derived from polymers having aromatic rings in their main chain or side chains have been proposed, since sulfonic acid group as the ion-exchange group can be easily introduced into the polymers.

The proposed examples include, a sulfonated membrane which is a sulfonated membrane comprising a graft polymer obtained by generating radicals with irradiating radioactive ray to poly (ethylene-alt-tetrafluoroethylene) or poly (tetrafluoroethylene), and grafting styrene (Electrochim. Acta. 40, 345 (1995) and polymer International, Volume 49 (12)/572 (2000)), a sulfonated styrene-butadiene copolymer (U.S. Pat. No. 5,468,574), and the like; these polymers are composed of an aliphatic unit substantially not introduced with an ion-exchange group and an aliphatic unit introduced with anion-exchange group and a main chain composed of an aliphatic repeating unit.

Other proposed examples include polymers in which sulfonic acid group is introduced into aromatic polyethers; for examples, sulfonated polyetherketone (JP 11-502249 A), sulfonated polyethersulfone (JP10-45913A and JP10-21943A), and the like; those proposed copolymers are composed of an aromatic unit substantially not introduced with an ion-exchange group and an aromatic unit introduced with an ion-exchange group.

The polyelectrolyte membrane composed of those copolymers as the effective component, however, has not yet had a sufficient performance of electricity generation for fuel cell.

### SUMMARY OF THE INVENTION

The inventors, after the diligent research to improve the conventional polymer having the ion-exchange group, has found that the specific polymer comprising an aromatic unit substantially not introduced with an ion-exchange group, and an aliphatic unit introduced with an ion-exchange group and having a main chain consisting of an aliphatic repeating unit, exhibits a high performance of electricity generation characteristics.

That is, the present invention provides a copolymer comprising an aromatic unit substantially free from an ion-exchange group, and an aliphatic unit having an ion-exchange group and a main chain consisting of an aliphatic repeating unit.

### PREFERABLE EMBODIMENTS OF THE PRESENT INVENTION

The present invention will be described in detail hereinafter.

A copolymer of the invention comprises an aromatic unit substantially free from an ion-exchange group, and an aliphatic unit having an ion-exchange group and a main chain consisting of an aliphatic repeating unit.

The term of “substantially free from an ion-exchange group” in the above description is defined that the average number of ion-exchange group introduced per a unit is less than 0.1.

The aromatic unit includes an unit of which main chain is mainly composed of aromatic rings; and the aromatic rings include monocyclic aromatic ring such as benzene, polycyclic aromatic ring such as naphthalene and biphenyl, heterocyclic aromatic ring such as pyridine, polycyclic-heterocyclic aromatic ring such as benzimidazole, and the like.

The aromatic unit, for examples, includes the units constituting polymers such as polyphenyleneether, polyphenylenesulfide, polynaphthylene, polyphenylene, polyethersulfone, polyetherethersulfone, polysulfone, polyetherketone, polyetheretherketone, polybenzimidazole, polyamide, polyimide, polyaramide, and the like. Among these, the units constituting polymers such as polyphenyleneether, polynaphthylene, polyphenylene, polyethersulfone, polyetherethersulfone and the like are prreferable. The unit constituting polyethersulfone is more preferably.

The aromatic ring in those aromatic units may have a substituent; the substituent, for example, includes alkyl group having carbon number from 1 to 6 such as methyl group, ethyl group, propyl group and the like, alkoxy group having carbon number from 1 to 6 such as methoxy group, ethoxy group and the like, aralkyl group having carbon number from 7 to 12 such as benzyl group and the like, aryl group such as phenyl group, naphthyl group, and the like, halogen substituent such as fluorine atom, chlorine atom, bromine atom and the like. The aromatic ring may have plural substituents and those plural substituents may be different each other. The substituent may have further other substituents in itself.

The unit having ion-exchange group of the invention includes an aliphatic unit having a main chain consisting of an aliphatic repeating unit and introduced with an ion-exchange group.

The aliphatic unit having a main chain consisting of an aliphatic repeating unit is not limited provided that the main chain is constituted by the aliphatic chain; the aliphatic unit includes, for example, the units constituting polymers such as polyethylene, polypropylene, polybutene, polybutadiene, polystyrene, poly (a-methylstyrene), polyvinylpyridine, polyvinylpyrrolidone, polymethacrylicester, polymethacrylicacid, polymethacrylicamide, polyacrylicester, polyacrylicacid, polyacrylicacidamide, polyvinylalcohol, and the like. The aliphatic repeating unit constituting the main chain of those units may be alkylene or alkylene of which hydrogen atoms are partly or wholly substituted by fluorine atoms.

And, the ion-exchange group may be introduced either into the main chain or into the side chain of the above described aliphatic unit, or be into both chains. The introduction into the side chain is preferable.

The ion-exchange group includes, for example, a cation-exchange group such as —SO₃H, —COOH, —PO(OH)₂, —P(OH)₂, and —SO₂NHSO₂— which is introduced into a main chain, and the like, and an anion-exchange group such as —NH₂, —NHR, —NRR′, —NRR′R″⁺, —NH₃⁺, and the like, wherein R, R′ and R″ independently represents alkyl group, cycloalkyl group, aryl group and the like, and R, R′ and R″ may be same or different each other. When the polyelectrolyte of the invention is used for a membrane of the solid polymer type fuel cell; the cation-exchange group is preferable; —SO₃H, —PO(OH)₂, —P(OH)₂, —SO₂NHSO₂— are more preferable; and —SO₃H is most preferable.

The aliphatic unit having the ion-exchange group includes the aforementioned unit; preferably the unit that the ion-exchange group is introduced in an unit constituting the polymers such as polyethylene, polybutene, polybutadiene, polystyrene, poly(a-methylstyrene), and that the ion-exchange group is also introduced in the unit constituting such polymers but hydrogen atoms of the such polymer constituents are partly or wholly replaced by fluorine atoms; more preferably the unit that the ion-exchange group is introduced in an unit constituting the polymers such as polystyrene, poly(a-methylstyrene), and that the ion-exchange group is also introduced in the unit constituting such polymers but hydrogen atoms of the such polymer constituents are partly or wholly replaced by fluorine atoms.

The binding manner of the copolymer comprising the aromatic unit substantially free from the ion-exchange group and the aliphatic unit having the ion-exchange group may be any types of block copolymer, random copolymer, alternating copolymer and graft copolymer.

In the case of block copolymer and graft copolymer, the aromatic unit and the aliphatic unit may be bonded directly or through a bonding group; however in the case of alternating copolymer and random copolymer, the aromatic unit and the aliphatic unit are preferably bonded directly.

The copolymer of the invention is preferably, in its binding manner, block copolymer and graft copolymer, more preferably block copolymer.

A number average molecular weight of the copolymer of the present invention is preferably in the range of from 2000 to 1000000, more preferably from 5000 to 500000, and most preferably from 8000 to 100000. If the number average molecular weight is less than 2000, the strength and heat durability of the copolymer may be decreased; if the number average molecular weight is more than 1000000, the solubility of copolymer to a solvent may be decreased during a producing process for a membrane mentioned later.

An ion-exchange group equivalent of the copolymer of the invention is usually in the range of from 0.01 to 5 mmol/g, preferably from 0.1 to 4 mmol/g, and more preferably from 0.5 to 3 mmol/g. If the value is less than 0.01 mmol/g, the copolymer may not be sufficient in its proton conductivity; if more than 5 mmol/g, may be decreased in its water resistance.

A method for producing the copolymer of the present invention will be described hereinafter.

The copolymer of the present invention comprises, as being aforementioned, the aromatic unit substantially free from ion-exchange group and the aliphatic unit having an ion-exchange group. The method for producing the copolymer is not particularly limited, any known methods are applicable. One example of methods includes a method where a copolymer comprising an aromatic unit and an aliphatic unit is prepared, followed by introducing an ion-exchange group in the aliphatic unit, and the like.

For example, a method for producing a copolymer comprising polyethersulfone and polystyrene according to the above described method includes a condensation reaction between the polyethersulfone having a functional group and the polystyrene having the functional group capable to react with the functional group of the polyethersulfone, and the like.

The combination of functional groups may be such that they can react each other; the preferable combination is halogen group and hydroxyl group, and a method for condensing the combinational functional groups in the presence of alkaline is preferable. The halogen functional group preferably includes fluoro group, chloro group, and the like.

In the case to bind polyethersulfone having hydroxyl group in its terminal end and polystyrene having hydroxyl group in its terminal end; those are bound by a method similar to the aforementioned condensation reaction, and the like, with using a binding group of dihalogen compounds such as 4,4′-difluorobenzophenone, 4,4′-dichlorobenzophenone, 4,4′-difluorodiphenylsulfone, 4,4′-dichlorodiphenylsulfone, bis(chloromethyl)benzene and the like, and of polyhalogen compounds such as decafluorobiphenyl and the like.

The polymer having aromatic unit such as polyethersulfone may use polymers obtained by synthesis or commercially available polymers. For example, the polyethersulfone having halogen and hydroxyl group in its terminal can be obtained from Sumitomo Chemical Co., Ltd. as SUMIKAEXCEL PES4100P (Chloro terminal), PES4003P (Hydroxyl terminal), and the like.

The polymer having aliphatic unit such as polystyrene may use polymers obtained by synthesis or commercially available polymers.

A method for synthesizing the polymer comprising the aliphatic unit having functional group in its terminal end includes, for example, a method where a functional group is introduced by copolymerizing the monomer having the functional group capable to react with the terminal and for propagation during the chain-growth polymerization. The polystyrene having hydroxyl group can be obtained by copolymerizing styrene monomer with the monomer having the hydroxyl group capable to react with the terminal end of for propagation styrene. The monomer having the hydroxyl group includes 1,1-diphenylethylene, 4-hydroxystyrene and the like, each of which being introduced with the hydroxyl group. Those monomers having the hydroxyl group may be introduced within the polystyrene chain or at its terminal end.

In the case that a function group possible to cause side reaction is contained in the monomer; for example, the aforementioned hydroxyl group can be used by being protected with known protection methods such as protecting the hydroxyl group with alkoxy group, siloxy group, ester group, and the like. In this case, the objected polymer can be obtained by removing the protection group by means of known method after polymerization being completed. The synthesis method is not limited, for example, such as radical polymerization, cation polymerization, anion polymerization, and the like can be applied.

As another method to obtain the aliphatic polymer having a functional group in its terminal end; a known method that a polymer introduced with a functional group at its terminal end is obtained by radical polymerization in the presence of a chain transfer agent (Chemical Reviews, 101 (12) 3689 (2001), Journal of Polymer Science Part A: Polymer Chemistry, 38 (12) 2121 (2000), these references are incorporated herein), and the like are illustrated.

The aforementioned condensation reaction to bind the polymer having the aromatic unit and the polymer having the aliphatic unit may be conducted in molten state without solvent, preferably be conducted in an appropriate solvent. The solvent used may be aromatic hydrocarbon solvent, ether solvent, ketone solvent, amide solvent, sulfone solvent, sulfoxide solvent, and the like; amide solvent is preferable because of its high solubility. The amide solvent includes N,N-dimethylformamide, N,N-dimethylacetoamide, N-metylpyrrolidone, and the like.

The reaction temperature is usually from about 20 to 250° C., preferably from 50 to 200° C.

A method for introducing sulfonic acid group as the ion-exchange group into the aliphatic unit of the copolymer, which is obtained as mentioned above and comprises the aromatic unit and the aliphatic unit, will be described hereinafter.

The sulfonation agent to introduce sulfuric acid group may be known sulfonation agents such as sulfuric acid of 90% or more in terms of the concentration, fuming sulfuric acid, chlorosulfuric acid, SO₃, and the like. Usage of sulfuric acid of 90% or more is preferable from the viewpoint point of to selectively sulfonating the aliphatic polymer.

The concentration of the sulfuric acid to the copolymer is preferably from 1 to 50% by weight, more preferably from 5 to 30% by weight. The reaction temperature is preferably from 0 to 80° C., more preferably from 20 to 60° C.

The sulfonation proceeds by dissolving the copolymer to the sulfuric acid, and its reaction finishes usually after from 2 to 100 hours at room temperature. The sulfonated copolymer can be recovered by a method such as pouring the sulfuric solution into water to precipitate the copolymer, and the like.

Thus obtained copolymer is usually used in a form of membrane for the usage of a polyelectrolyte of the fuel cell. The thickness of the membrane is not limited, preferably from 10 to 300 micron-meter, more preferably from 15 to 200 micron-meter. From the viewpoint of gaining a film having the strength durable to the practical use, the thickness is preferably more than 10 micron-meter; from the viewpoint of gaining reduce membrane resistance, that is, of improving electricity generation performance, the thickness is preferably less than 300 micron-meter.

A method of forming the copolymer of the invention to a membrane is not limited; the method of forming the membrane from the solution state is preferred.

Specifically, the membrane is formed by dissolving the copolymer to an appropriate solvent to cast the dissolved solution on a substrate, followed by removal of the solvent. The solvent used for membrane formation is not limited provided that it can dissolve the copolymer and thereafter be removed. Preferably used solvents are polar solvent such as N,N-dimethylformamide, N,N-dimethylacetoamide, N-methyl-2-pyrrolidone, dimethylsulfoxide, and the like; halogenous solvent such as dichloromethane, chloroform, 1,2-dichloroethane, chlorobenzene, dichlorobenzene, and the like; alcohol such as methanol, ethanol, propanol, and the like; alkyleneglycolmonoalkylether such as ethyleneglycolmonomethylether, ethyleneglycolmonoethylether, propyleneglycolmonomethylether, propyleneglycolmonoethylether, and the like. Those solvents may be used solely or, if necessary, in a mixture of more than two solvents. Among of them, dimethylformamide, dimethylacetoamide, N-methylpyrrolidone, dimethylsulfoxide, dichloromethane/alcohol mixture, chloroform/alcohol mixture are preferable in terms of their high solubility to the polymer.

The substrate applied for membrane formation is not limited provided that it is resistible against the solvent and ensures for the membrane to be easily peeled off after the formation; usually used substrates are glass plate, PET(polyethyleneterephthalate) film, stainless plate, stainless belt, silicon wafer, Teflon(registered trademark) plate, and the like. These substrates may have such surfaces as to be treated for easy releasability, embossed or matt-finished, if necessary. The membrane thickness may be controlled by adjusting the solution concentration or the cast thickness on the substrate.

When the copolymer of the invention is used for the polyelectrolyte of the fuel cell, it may contain, if necessary, additives used for polymers such as plasticizer, stabilizer, mold lubricant, humectants, and the like. Further, the copolymer may be conjugated with a porous membrane to produce a conjugated polyelectrolyte membrane having improved mechanical strength. Furthermore, the polyelectrolyte membrane of the invention may be applied by the known cross linking method which bridges membranes by irradiating electron beam or radioactive rays for the purpose to improve the mechanical strength of the membranes.

A fuel cell of the invention will be described hereinafter.

The fuel cell of the invention includes the cell using the copolymer of the invention as a polyelectrolyte membrane, and the cell using the polymer polyelectrolyte of the invention as a polyelectrolyte in a catalyst layer, and the like.

The fuel cell using the copolymer of the invention as the polyelectrolyte membrane may be formed by assembling a catalyst and a gas diffusion layer on the both sides of the polyelectrolyte membrane. The gas diffusion layer used may be known materials; a porous carbon woven fabric, a porous carbon nonwoven fabric or carbon paper is preferable for the purpose to efficiently transport source gases to the catalyst.

The catalyst is not particularly limited provided that it is capable of activating the oxidation-reduction reaction between hydrogen and oxygen; any known catalysts may be used; the fine particles of platinum is preferable. The fine particles of platinum are often used by being supported on particulate or fibrous carbon of activated carbon or graphite. A catalyst layer is produced by coating a paste of the catalyst compound, the paste which is formed by mixing the platinum particles supported on the carbon into a alcohol solution of perfluoroalkylsulfonicacid resin employed as the polyelectrolyte to form a paste, on the gas diffusion layer and/or a polyelectrolyte membrane, followed by drying. For example, the way disclosed in J. Electrochem. Soc.: Electrochemical Science and Technology, 1988, 135 (9), 2209 maybe applied (these references are incorporated herein).

The fuel cell using the copolymer of the invention as the polyelectrolyte in the catalyst layer may includes the catalyst compound constituted with the copolymer of the invention in place of the aforementioned perfluoroalkylsulfonicacid resin constituent. The solvent capable for producing the catalyst layer using the copolymer of the invention may include the same solvents applicable in aforementioned membrane formation with using the copolymer of the invention. When the catalyst layer applying the copolymer of the invention is used, the polyelectrolyte membrane is not limited to the membrane employed with the copolymer of the invention but other polyelectrolyte membranes may be used.

### EXAMPLES

The present invention is described below in more detail with reference to the following Examples, but it should not be construed that the invention is limited thereto.

Evaluation of Fuel Cell Characteristics

The platinum catalyst supported on carbon was mixed with lower alcohol (containing 10 percent by weight of water, manufactured by Aldlich Co., Ltd.) solution of Nafion (a registered tradename of DuPont Co., Ltd.) to produce the paste, followed by coating the paste on the porous carbon woven fabric as the electrode material and then by drying to obtain a current collector as the catalyst-fixed electrode material. The current collectors bonded on both surfaces of the membrane to obtain the currentcollector-membrane assembly. By allowing moistened air to flow through one surface and moistened hydrogen gas through the other surface of the assembly which is kept at 80 degree C., the evaluation was carried out by measuring the electricity generation characteristics of the assembly.

### Reference Example 1

### Synthesis of Potassium Naphthalene

150 ml of dehydrated purified tetrahydrofuran (abbreviated to THF hereinafter) was fed into the flask of the argon atmosphere, followed by addition of 3.9 g of metal potassium and 15.4 g of naphthalene; the mixture was reacted at room temperature to synthesize dark green color potassium naphthalene of THF solution. According to the methanol titration of which end point is defined as disappearance of green color, the concentration was 0.369 mol/L.

### Reference Example 2

### Synthesis of Diphenylethylens

5.01 g (25.3 mmol) of 4-hydroxybenzophenone and 8 ml of DMF were fed into the flask under the nitrogen atmosphere to dissolve. DMF solution containing 5.47 g (36.3 mmol) of tert-butyldimethylsilylchloride and 8.00 g (118 mmol) of imidazole was dropped into the flask for 10 minutes at room temperature. The mixture was stirred for 5 hours at room temperature, followed by gentle addition of excess amount of aqueous sodium bicarbonate and then by extraction with 30 ml of hexane. The organic phase was washed by water, followed by drying and removal of solvent to obtain 7.40 g of colorless transparent liquid (a).

8.93 g (25 mmol) of methyltriphenylphosphoniumbromide and 3.60 g (32.1 mmol) of tert-butoxypotassium were fed into the flask under the argon atmosphere, followed by addition of 30 ml of THF to dissolve. The solution of 7.40 g of (a) dissolved in 15 ml of THF was dropped into the flask for 15 minutes at 0 degree C., followed by stirring for 18 hours at room temperature. The reaction mixture was added with water to cease reaction, followed by distilling out THF, thereafter by being extracted for three times with 20 ml of ether, and then the organic phase was washed by water. After the organic phase being dried, the precipitated was collected by filtration with pouring abundant amount of hexane, followed by purification with a column chromatography of which eluent was hexane, thereafter by distilling out hexane to obtain 4.24 g of 1-(4′-tert-butyldimethylsiloxyphenyl)-1-phenylethylene (b).

### Reference Example 3

### Production of Polystyrenes (c)

4.21 ml (1.55 mmol) of THF solution of the potassium naphthalene synthesized in above described Reference Example 1 was fed into the glass vessel that was vacuumed. The solution in the vessel was kept at −78° C. and stirred during the addition of THF solution of styrene (22.7 mmol). After the reaction solution being reacted for 10 minutes at −78° C., it was added with 7.45 ml of THF solution (0.221 mmol/ml) of (b) synthesized in above described Reference Example 2, followed by reaction for two hours. Thereafter, the reaction solution was added with methanol to stop reaction, then the reactant was fed into methanol to obtain polymer (c1). (c1) was dissolved in 15 ml of THF, followed by addition of 3 ml of THF solution (1 mmol/ml) of tetrabutylammoniumfluoride to react for two hours at room temperature. Thereafter, the reaction solution was poured in methanol to precipitate polymer, followed by filtration and drying to obtain polymer (c). The number average molecular weight measured by GPC was 4300 in terms of polystyrene. And, it was observed that the polymer has polystyrene structure substituted with hydroxy group at its terminal end.

### Reference Example 4

### Synthesis of Polyethersulfones

25 g of polyethersulfone having hydroxyl group terminal end (manufactured by Sumitomo Chemical Co., Ltd., SUMIKAEXCEL PES4003P) was dissolved in 65 ml of N,N-dimethylacetoamide (abbreviated to DMAc hereinafter) under the nitrogen atmosphere. Furthermore, the dissolved solution was added with 0.277 g of potassium carbonate, 1.34 g of decafluorobiphenyl and 13 ml of toluene to react for two hours at 80° C. and subsequently for 1 hour at 100° C. Thereafter, the reaction solution was fed in methanol to precipitate the polymer, followed by filtration and drying to obtain polyethersulfones (d). This was identified as polyethersulfone substituted with nonafluorobiphenyloxy group at its terminal end.

### Example 1

0.15 g of aforementioned (c) and 0.90 g of aforementioned (d) were fed under the nitrogen atmosphere, followed by dissolution of 10 ml of DMAc with stirring. The solution was further added with 15 mg of potassium carbonate and 10 ml of toluene, followed by reaction for three hours at 100° C., subsequently for three hours at 120 degree C., and then for six hours at 140° C. Thereafter, the reaction solution was fed into abundant hydrochloric acidic methanol to precipitate polymer, followed by filtration and drying to obtain 0.96 g of block copolymer (e) having polyethersulfone-block-polystyrene structure.

0.96 g of block copolymer (e) obtained was dissolved in 15 ml of concentrated sulfuric acid, followed by reaction for three days at 40° C.; subsequently, the reaction solution was dropped into abundant iced water to collect the precipitation by filtration. Furthermore, the collected precipitation was repeatedly rinsed with ion-exchanged water until the rinsed water exhibited neutral, followed by drying to obtain sulfonated polymer (f) (block copolymer having polyethersulfone-block-sulfonatedpolystyrene structure). According to the GPC measurement with DMAc eluent, the number average molecular weight was 73000 in terms of polystyrene.

(f) was dissolved in DMAC to prepare the solution of 15 percent by weight. The solution was cast on the glass substrate, followed by drying at 80° C. to obtain the membrane (g) of sulfonated aromatic polymer. The membrane thickness of (g) was 34 micron-meter. The results of (g) about the ion-exchange capacity measurement carried out by a titration method and about the fuel cell characteristics evaluation are shown in Table 1.

### Comparative Example 1

99 mg of anhydrous cuprous chloride, 266 mg of 2-methylbenzoxazole and 1 ml of toluene were stirred for 15 minutes at room temperature. The solution obtained was added with 8.5 g of 2-phenylphenol and 30 ml of toluene, followed by stirring for five hours at 50° C. under oxygen atmosphere. After reaction having finished, the reaction solution was poured into methanol containing hydrochloric acid to precipitate polymer, followed by filtration and drying to obtain poly(2-phenylphenyleneether) (h).

3.0 g of polyethersulfone having hydroxyl group terminal end (manufactured by Sumitomo Chemical Co., Ltd., SUMIKAEXCEL PES5003P), 0.75 g of (h), 0.04 g of potassium carbonate, 15 ml of N,N-dimethylacetoamide (abbreviated toDMAc hereinafter) and 3 ml of toluene were fed in the flask equipped with the azeotropic distillation device, followed by heating with stirring to dehydrate under the toluene-water azeotropic condition, subsequently by removal of toluene by distillation. Thus obtained solution was added with 0.05 g of 4,4′-difluorobenzophenone, followed by heating for five hours at 160 degree C. with stirring. The reaction solution was dropped into abundant hydrochloric acidic methanol, subsequently obtained precipitation was collected by filtration, followed by drying under the reduced pressure at 80° C. to obtain 3.8 g of block copolymer.

2 g of block copolymer obtained was stirred together with 20 ml of 98% sulfuric acid at room temperature to form homogeneous solution, followed by further stirring for two hours. The solution obtained was dropped into abundant iced water to collect the precipitation by filtration. Furthermore, the collected precipitation was repeatedly rinsed with ion-exchanged water by means of mixer washing until the rinsed water exhibited neutral, followed by drying at 40° C. under the reduced pressure to obtain block copolymer (i) having polyethersulfone-block-sulfonatedpoly(2-phenylphenylene-ether) structure. According to the GPC measurement with DMAc eluent, the number average molecular weight was 51000 in terms of polystyrene.

(i) was dissolved in DMAc to prepare the solution of 15 percent by weight. The solution was cast on the glass substrate, followed by drying at 80° C. to obtain the membrane (j) of sulfonated aromatic polymer. The membrane thickness of (j) was 35 micron-meter. The results of (j) about the ion-exchange capacity measurement carried out by a titration method and about the fuel cell characteristics evaluation are shown in Table 1.

TABLE 1

| | | Fuel Cell Characteristics | |
|---|---|---|---|
| | | Evaluation | |
| | Ion-Exchange | Cell Voltage | Current Density |
| | Capacity | at 0.50 A/cm² of | at 0.20 V of Cell |
| | (meq/g) | Current Density | Voltage |
| Example 1 | 1.24 | 0.61 V | 1.70 A/cm² |
| Comparative | 1.77 | 0.59 V | 1.25 A/cm² |
| Example 1 | | | |

The copolymer of the invention is useful as polyelectrolyte for fuel cell and others, and the fuel cell employing this polyelectrolyte exhibits high electricity generation characteristics.

1. A copolymer comprising an aromatic unit substantially free from an ion-exchange group, and an aliphatic unit having an ion-exchange group and a main chain consisting of an aliphatic repeating unit.

2. The copolymer according to claim 1, wherein the aromatic unit is selected from the group consisting of the following polymers: polyphenyleneether, polyphenylenesulfide, polynaphthylene, polyphenylene, polyethersulfone, polyetherethersulfone, polysulfone, polyetherketone, polyetheretherketone, and polybenzimidazole.

3. The copolymer according to claim 1, wherein the aliphatic unit is selected from the group consisting of the following polymers: polyethylene, polypropylene, polybutene, polybutadiene, polystyrene, poly(amethylstyrene), polyvinylpyridine, polyvinylpyrrolidone, polymethacrylicester, polymethacrylicacid, polymethacrylicamide, polyacrylicester, polyacrylicacid, polyacrylicacidamide, and polyvinylalcohol.

4. The copolymer according to claim 1, wherein the ion-exchange group is a cation-exchange group selected from the group consisting of —SO₃H, —COOH, —PO(OH)₂, —P(OH)₂, and —SO₂NHSO₂—.

5. The copolymer according to claim 1, wherein a number average molecular weight of the copolymer is from 2000 to 1000000.

6. The copolymer according to claim 1, wherein the copolymer is a block copolymer or a graft copolymer.

7. The copolymer according to claim 1, wherein an ion-exchange group equivalent is from 0.01 to 5 mmol/g.

8. A polyelectrolyte comprising the copolymer according to claim 1 as an effective component.

9. A membrane comprising the polyelectrolyte according to claim 8.

10. An electrode catalyst compound for a fuel cell comprising the polyelectrolyte according to claim 8.

11. A fuel cell comprising the membrane according to claim 9.

12. A fuel cell comprising the electrode catalyst compound according to claim 10.
